(19) United States
(12) Patent Application Publication
(10) Pub. No.: US 2022/0229713 A1
(43) Pub. Date: Jul. 21, 2022

(54) MONITORING SYSTEM, MONITORING METHOD, AND NON-TRANSITORY STORAGE MEDIUM

(71) Applicant: NEC Corporation, Minato-ku, Tokyo (JP)

(72) Inventor: Akio NORIMATSU, Tokyo (JP)

(73) Assignee: NEC Corporation, Minato-ku, Tokyo (JP)

(21) Appl. No.: 17/619,371

(22) PCT Filed: Jan. 20, 2020
(86) PCT No.: PCT/JP2020/001657

§ 371 Date: Dec. 15, 2021

(30) Foreign Application Priority Data
Jun. 27, 2019 (JP) 2019-120168

(51) Int. Cl. G06F 11/07; G06F 11/34

(52) U.S. Cl. CPC G06F 11/079; G06F 11/3495

(57) ABSTRACT

The present invention provides a monitoring system (1) including: a monitoring execution unit (101) that monitors each of a plurality of monitoring targets and outputs an event indicating discrimination information of the monitoring target and an event being occurring in the monitoring target; an event management unit (201) that updates, based on the event output by the monitoring execution unit (101), an event correlation DB (204) that stores information indicating event types having occurred and a status value indicating an occurrence of each of the event types and a magnitude of an elapsed time from the occurrence; a correlation-degree analysis unit (202) that determines, based on configuration information indicating a mutual relation among a plurality of monitoring targets, one or a plurality of second monitoring targets having a predetermined relation with a first monitoring target relating to a first event; a correlation-degree learning unit (203) that determines a correlation-degree weight between a fault event type indicating a fault occurrence among the event types of the first monitoring target and the second monitoring target and other event type, based on the status values of the fault event type and the other event type; and a monitoring control unit (102) that outputs information to an output apparatus, wherein the correlation-degree analysis unit (202) analyzes, based on the correlation-degree weight determined by the correlation-degree learning unit (203), whether the first event is a sign for any one of the fault event types, and the monitoring control unit (102) outputs an analysis result based on the correlation-degree analysis unit (202).

### TECHNICAL FIELD

The present invention relates to a monitoring system, a monitoring method, and a program.

### BACKGROUND ART

It is generally detected that a fault affecting a system such as an information and communication technology (ICT) system and the like occurs, and in recent years, a demand for desiring to recognize a sign before a fault occurs is increasing. Therefore, an existing technique for detecting a fault sign, there are methods as follows.
<Method 1> A causal relation between a sign event and a fault event, both being known, is described as a rule, and based on the rule, determination is performed (event correlation and rule-based AI).
<Method 2> At a time of occurrence of a known fault, a monitoring system provides an event list within a predetermined time and a monitoring person registers the list as a sign event, and thereby a known fault associated at a time of subsequent sign detection is provided (Patent Document 1).
<Method 3> With regard to data based on various sensors, a correlation with a fault event is generated, based on supervised machine learning, as a probability model (a Bayesian network, a neural network, or the like) and a fault event being occurring with high probability is predicted from sensor data (Patent Document 2).

### RELATED DOCUMENT

### Patent Document

[Patent Document 1] Japanese Patent Application Publication No. 2016-201060

[Patent Document 2] Japanese Patent Application Publication No. 2018-116545

### DISCLOSURE OF INVENTION

### Technical Problem

<Method 1> has produced a problem in that when a causal relation between a sign event and a fault event is not able to described based on a mathematical expression or the like, rulemaking itself can not be achieved. <Method 2> has produced a problem in that a monitoring person performs manual selection from an event list within a predetermined time, and therefore arbitrariness exists and it is difficult to guarantee a causal relation between a sign event and a fault event. <Method 3> has produced a problem in that while a correlation between sensor data to be a sign and a fault event is guaranteed based on a probability model, supervised learning is required, and therefore prediction accuracy is poor other than a system capable of accurately generating training data. An issue according to the present invention is to solve these problems existing in a conventional method of detecting a fault sign.

### Solution to Problem

According to the present invention, a monitoring system including:

a monitoring execution means that monitors each of a plurality of monitoring targets and outputs an event indicating discrimination information of the monitoring target and an event being occurring in the monitoring target;

an event management means that updates, based on the event output by the monitoring execution means, an event correlation database that stores information indicating event types having occurred and a status value indicating an occurrence of each of the event types and a magnitude of an elapsed time from the occurrence;

a correlation-degree analysis means that determines, based on configuration information indicating a mutual relation among the plurality of monitoring targets, one or a plurality of second monitoring targets having a predetermined relation with a first monitoring target relating to a first event output by the monitoring execution means;

a correlation-degree learning means that determines a correlation-degree weight between a fault event type indicating a fault occurrence among the event types of the first monitoring target and the second monitoring target and other event type, based on the status values of the fault event type and the other event type; and

a monitoring control means that outputs information to an output apparatus, wherein

the correlation-degree analysis means analyzes, based on the correlation-degree weight determined by the correlation-degree learning means, whether the first event is a sign for any one of the fault event types, and

the monitoring control means outputs an analysis result based on the correlation-degree analysis means

is provided.

Further, according to the present invention,

a monitoring method including:

by a computer,

monitoring each of a plurality of monitoring targets and outputting an event indicating discrimination information of the monitoring target and an event being occurring in the monitoring target;

updating, based on the event, an event correlation database that stores information indicating event types having occurred and a status value indicating an occurrence of each of the event types and a magnitude of an elapsed time from the occurrence;

determining, based on configuration information indicating a mutual relation among the plurality of monitoring targets, one or a plurality of second monitoring targets having a predetermined relation with a first monitoring target relating to a first event;

determining a correlation-degree weight between a fault event type indicating a fault occurrence among the event types of the first monitoring target and the second monitoring target and other event type, based on the status values of the fault event type and the other event type;

analyzing, based on the determined correlation-degree weight, whether the first event is a sign for any one of the fault event types; and

outputting an analysis result

is provided.

Further, according to the present invention,

a program causing a computer to function as:

a monitoring execution means that monitors each of a plurality of monitoring targets and outputs an event indicating discrimination information of the monitoring target and an event being occurring in the monitoring target;

an event management means that updates, based on the event output by the monitoring execution means, an event correlation database that stores information indicating event types having occurred and a status value indicating an occurrence of each of the event types and a magnitude of an elapsed time from the occurrence;

a correlation-degree analysis means that determines, based on configuration information indicating a mutual relation among the plurality of monitoring targets, one or a plurality of second monitoring targets having a predetermined relation with a first monitoring target relating to a first event output by the monitoring execution means;

a correlation-degree learning means that determines a correlation-degree weight between a fault event type indicating a fault occurrence among the event types of the first monitoring target and the second monitoring target and other event type, based on the status values of the fault event type and the other event type; and

a monitoring control means that outputs information to an output apparatus, wherein

the correlation-degree analysis means analyzes, based on the correlation-degree weight determined by the correlation-degree learning means, whether the first event is a sign for any one of the fault event types, and

the monitoring control means outputs an analysis result based on the correlation-degree analysis means

is provided.

### Advantageous Effects of Invention

According to the present invention, the problems described above existing in a conventional method of detecting a fault sign can be solved.

### BRIEF DESCRIPTION OF THE DRAWINGS

The above-described object, other objects, features, and advantages will become more apparent from preferred example embodiments described below and the following accompanying drawings.

FIG. 1 is a diagram illustrating one example of a function block diagram of a monitoring system according to a present example embodiment.

FIG. 2 is a diagram schematically illustrating one example of information processed by the monitoring system according to the present example embodiment.

FIG. 3 is a diagram for illustrating one example of processing executed by the monitoring system according to the present example embodiment.

FIG. 4 is a diagram schematically illustrating one example of information processed by the monitoring system according to the present example embodiment.

FIG. 5 is a diagram schematically illustrating one example of information processed by the monitoring system according to the present example embodiment.

FIG. 6 is a diagram for illustrating one example of processing executed by the monitoring system according to the present example embodiment.

FIG. 7 is a flowchart illustrating one example of a flow of processing of the monitoring system according to the present example embodiment.

FIG. 8 is a flowchart illustrating one example of a flow of processing of the monitoring system according to the present example embodiment.

FIG. 9 is a flowchart illustrating one example of a flow of processing of the monitoring system according to the present example embodiment.

FIG. 10 is a flowchart illustrating one example of a flow of processing of the monitoring system according to the present example embodiment.

FIG. 11 is a diagram illustrating one example of a hardware configuration of the monitoring system according to the present example embodiment.

FIG. 12 is a diagram schematically illustrating one example of information processed by the monitoring system according to the present example embodiment.

### DESCRIPTION OF EMBODIMENTS

A monitoring system according to a present example embodiment is described in detail. The monitoring system includes a function for monitoring a system such as an ICT system and the like and detecting/reporting a fault.

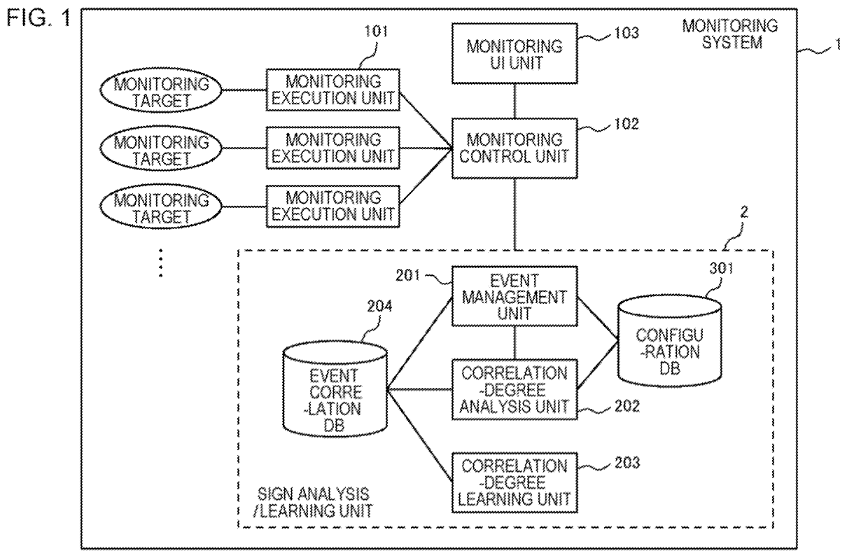

FIG. 1 illustrates one example of a function block diagram of a monitoring system 1 according to the present example embodiment. As illustrated, the monitoring system 1 includes a monitoring execution unit 101, a monitoring control unit 102, a monitoring user interface (UI) unit 103, and a sign analysis/learning unit 2. The sign analysis/learning unit 2 includes an event management unit 201, a correlation-degree analysis unit 202, a correlation-degree learning unit 203, an event correlation database (DB) 204, and a configuration DB 301. Note that, the monitoring system 1 may not necessarily include at least either of the event correlation DB 204 and the configuration DB 301. In this case, an external apparatus configured to be communicable with the monitoring system 1 includes at least either of the event correlation DB 204 and the configuration DB 301. Hereinafter, a configuration of each of function units is described.

The monitoring execution unit 101 monitors each of a plurality of monitoring targets included in a monitoring-target system and outputs an event indicating discrimination information of a monitoring target and an event being occurring in the monitoring target.

The monitoring-target system is any system such as an ICT system and the like. A monitoring target is a resource existing inside the monitoring-target system. The resource is exemplified as, but not limited to, for example, hardware, an operating system, middleware, an application, a file, and the like. A method of monitoring a monitoring target is not specifically limited according to the present example embodiment. For example, a method of executing real-time monitoring such as life-or-death monitoring, log monitoring, threshold monitoring, and the like is employable, and a monitoring method such as baseline monitoring based on past data, feature value detection based on a statistical method, and the like is employable. Further, there are various timings at which the monitoring execution unit 101 outputs an event, and output may be made, for example, at every predetermined time previously determined.

The monitoring control unit 102 acquires an event output by the monitoring execution unit 101. Then, the monitoring control unit 102 notifies, via the monitoring UI unit 103, a monitoring person of an event occurrence. When, for example, the acquired event indicates a predetermined fault event, the monitoring control unit 102 may output, via the monitoring UI unit 103, information indicating an occurrence of a fault event to a monitoring person. Note that, when the acquired event does not indicate a predetermined fault event, the monitoring control unit 102 may not necessarily notify of an event occurrence via the monitoring UI unit 103.

Further, the monitoring control unit 102 transfers the acquired event to the sign analysis/learning unit 2. Then, the monitoring control unit 102 acquires, from the sign analysis/learning unit 2, an analysis result (detected sign) based on the transferred event ,and notifies, via the monitoring UI unit 103, a monitoring person of the analysis result.

Note that, according to the present description, “acquisition” includes at least any one of a matter that “a local apparatus fetches data stored in another apparatus or a storage medium (active acquisition)”, based on user input or based on an instruction from a program, for example, a matter that reception is executed by making a request or an inquiry to another apparatus, a matter that reading is executed by accessing another apparatus or a storage medium, and the like; a matter that “data output from another apparatus are input to a local apparatus (passive acquisition)” based on user input or based on an instruction from a program, for example. a matter that waiting is made in a state where data transmitted from an external apparatus are receivable and data transmitted from an external apparatus are received, a matter that data distributed (or transmitted, notified on a push basis, or the like) from an external apparatus are received, and a matter that selective acquisition is executed from among received pieces of data or information; and a matter that “new data are generated by data editing (conversion to text, data rearrangement, partial data extraction, file-format modification, and like) and the new data are acquired”.

The monitoring UI unit 103 outputs information via any output apparatus such as a display, a projection apparatus, a speaker, a mailer, and a printer. The monitoring UI unit 103 outputs, for example, an event being occurring in a monitoring-target system and an analysis result (a detected sign) based on the sign analysis/learning unit 2.

The sign analysis/learning unit 2 executes, based on events acquired from the monitoring control unit 102, self-learning for a magnitude of a correlation degree indicating a causal relation among a plurality of event types. Then, the sign analysis/learning unit 2 extracts, by using the learned correlation degree, an event type having a causal relation (a large correlation degree) with a predetermined event (e.g., an event having newly occurred) and provides the extracted event type to the monitoring control unit 102.

According to the present example embodiment, an event output by the monitoring execution unit 101 is classified into a plurality of event types. A plurality of event types are different from each other in at least either of discrimination information of a monitoring target and an event being occurring in a monitoring target. In other words, a plurality of events matched with respect to both of discrimination information of a monitoring target and an event being occurring in a monitoring target belong to the same event type.

The event management unit 201 manages event types (event types having occurred so far) to be a target for learning a correlation degree and states of each of the event types. Specifically, the event management unit 201 updates, based on an event output by the monitoring execution unit 101, the event correlation DB 204 storing information indicating event types having occurred so far and a status value indicating an occurrence of each of the event types and a magnitude of an elapsed time from the occurrence.

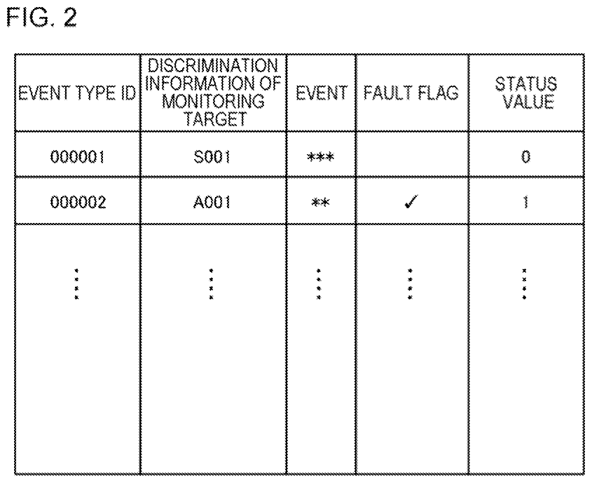

FIG. 2 schematically illustrates one example of information stored in the event correlation DB 204. In the illustrated example, an event type identifier (ID) being information for discriminating a plurality of event types having occurred from one another, discrimination information of a monitoring target indicated by an event belonging to each event type and a content of an event, a fault flag indicating whether each event is a fault event, and a status value of each event type are associated with each other.

The event management unit 201 confirms, when the monitoring execution unit 101 outputs a new event, whether an event type matched with the new event with respect to both of discrimination information of a monitoring target and an event being occurring in a monitoring target is registered in the correlation DB 204. When being not registered, the event management unit 201 registers the new event in the event correlation DB 204 as a new event type, and registers a previously-determined initial value as a status value. On the other hand, when being registered, the event management unit 201 updates, to an initial value, a status value of an event type to which the new event belongs. In this manner, the event management unit 201 updates information of an event type to which a new event output by the monitoring execution unit 101 belongs.

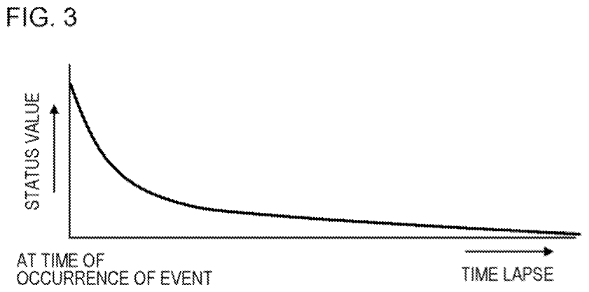

Further, the event management unit 201 changes, in response to a time lapse, a status value of an event type registered in the event correlation DB 204. For example, an initial value set at a time of occurrence of an event is maximum, and then the event management unit 201 decreases a status value as time elapses. The event management unit 201 can recompute and update, at any timing (e.g., every predetermined time), a status value of each of event types registered in the event correlation DB 204, based on a function (see FIG. 3) where a value gradually decreases in response to a time lapse such as a linearly decreasing function, an inversely proportional function, and the like.

The correlation-degree analysis unit 202 determines, based on configuration information indicating a mutual relation among a plurality of monitoring targets, one or a plurality of second monitoring targets having a predetermined relation with a first monitoring target relating to a new event (hereinafter, referred to as a “first event”) output by the monitoring execution unit 101. The first monitoring target and the second monitoring target are configurationally close to each other (e.g., a server that executes processing is the same, and the like), and therefore, a causal relation may exist between events being occurring in both targets. While a content of the “predetermined relation” described above is not specifically limited, such a relation between a first monitoring target and a second monitoring target can be defined based on various methods.

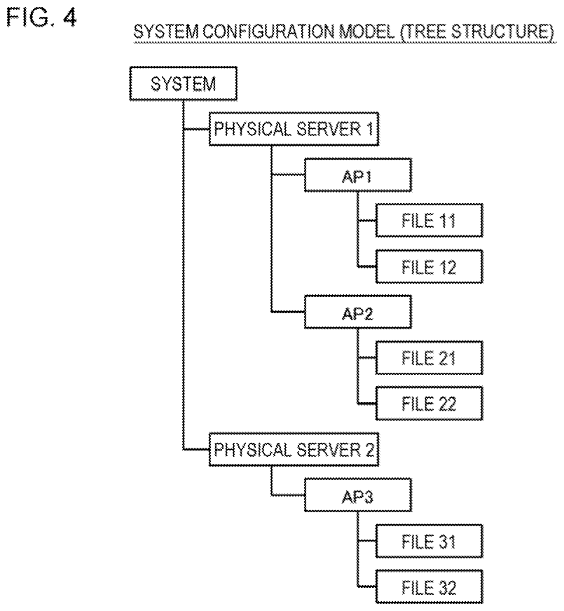

Herein, one example is described. FIG. 4 schematically illustrates one example of configuration information. As illustrated, a mutual relation among a plurality of monitoring targets may be managed based on a hierarchical tree structure. Then, the correlation-degree analysis unit 202 may determine, in the tree structure, one or a plurality of second monitoring targets having a predetermined relation with a first monitoring target. For example, another monitoring target hanging from a predetermined node (a superordinate node of a first monitoring target) from which the first monitoring target hangs may be determined as a second monitoring target. The predetermined node may be a superordinate node on an M-th (M is an integer equal to or more than 1) layer upper from a first monitoring target.

In the example illustrated in FIG. 4, when, for example, a first monitoring target is a “file 11”, another monitoring target “file 12” hanging from a node “AP 1” from which the “file 11” hangs may be determined as a second monitoring target. As another example, when a first monitoring target is the “file 11”, other monitoring targets “AP 1”, “file 12”, “AP2”, “file 21”, and “file 22” hanging from a node “physical sever 1” from which the “file 11” hangs may be determined as a second monitoring target.

Note that, a configuration of monitoring target events may be modified. Therefore, the above-described monitoring control unit 102 may include a function for automatically updating configuration information, based on an event output by the monitoring execution unit 101.

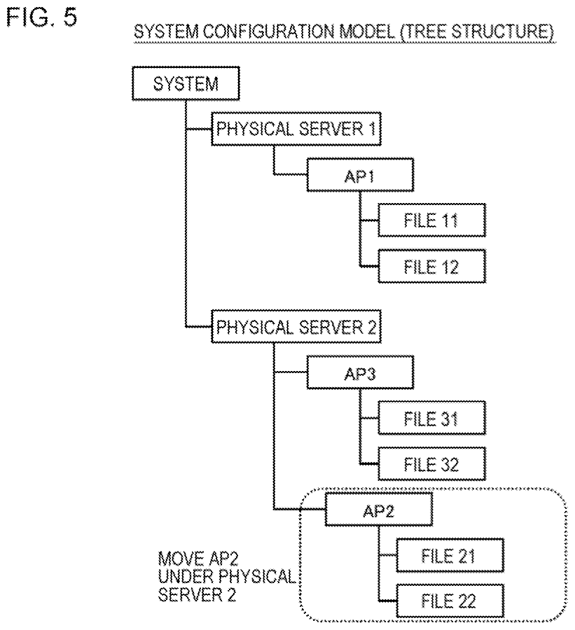

When, for example, a first monitoring target described in an event output by the monitoring execution unit 101 does not exist in configuration information managed in the configuration DB 301, the monitoring control unit 102 adds the first management target, as a new node, under a second monitoring target node in the event. Further, even when a first monitoring target exists, the first monitoring target is added under a second monitoring target node, similarly to a case where the second monitoring target is not a superordinate node. In this manner, the configuration information illustrated in FIG. 4 is updated to configuration information illustrated in FIG. 5.

Further, the correlation-degree analysis unit 202 can analyze, based on a correlation-degree weight determined by the correlation-degree learning unit 203 described below, whether a first event is a sign for any one of fault event types. Details of the processing is described later.

The correlation-degree learning unit 203 includes a function for learning a causal relation between event types. Specifically, the correlation-degree learning unit 203 determines a correlation-degree weight between a fault event type indicating a fault occurrence among event types of the first monitoring target described above and the second monitoring target described above and other event type, based on status values of the fault event type and the other event type.

An “event type of a first monitoring target” is an event type to which an event being occurring in a first motoring target belongs and, for example, “discrimination information of a monitoring target” in an event type illustrated in FIG. 2 is an event type indicating a first monitoring target.

An “event type of a second monitoring target” is an event type to which an event being occurring in a second motoring target belongs and, for example, “discrimination information of a monitoring target” in an event type illustrated in FIG. 2 is an event type indicating a second monitoring target.

A “fault event type” is an event type in which an event is a fault event and, for example, is an event type in which a fault flag is set among event types illustrated in FIG. 2.

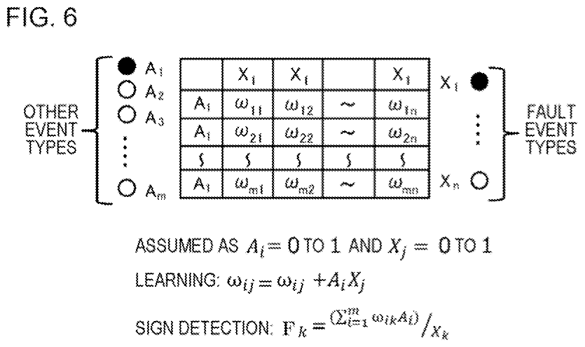

By using FIG. 6, an outline of processing based on the correlation-degree learning unit 203 is described. A₁ to Aₘ each are a status value of each of m other event types among event types of a first monitoring target and a second monitoring target. X₁ to Xₙ each are a status value of each of n fault event types among the event types of the first monitoring target and the second monitoring target. Symbols ω₁₁ to ωₘₙ each are a correlation-degree weight of each of m×n combinations formed with any one of m other event types and any one of n fault event types.

The correlation-degree learning unit 203 repeatedly computes correlation-degree weights ω₁₁ to ωₙₘ at any timing (e.g., every predetermined time). As described above, a status value changes as time elapses, and therefore, it is possible that at least one of A₁ to Aₘ and X₁ to Xₙ changes, at each timing, from a value at a timing immediately before the each timing.

In determination processing for the correlation-degree weight between a first fault event type (status value X₁) and a first other event type (status value A₁) at a first determination timing, the correlation-degree learning unit 203 can determine, as illustrated in a computational equation of “learning” in FIG. 6, as a correlation-degree weight, a value acquired by correcting (adding A₁×X₁ to), based on the status value X₁ of the first fault event type and the status value A₁ of the first other event type at the first determination timing, the correlation-degree weight ω₁₁ between the first fault event type and the first other event type determined at a last determination timing. In this case, as the status value X₁ of the first fault event type and the status value A₁ of the first other event type at the first determination timing is larger, an increase width of a correlation-degree weight based on correction becomes larger. According to such a computational equation, as occurrences arise at closer timings, a correlation-degree weight in a combination of two event types with respect to the occurrences becomes larger. Note that, the illustrated correction method (addition of a product of A₁ and X₁) is merely one example, and another method is employable when an effect as described above is acquired.

Herein, processing, by the correlation-degree analysis unit 202, of analyzing, based on a correlation-degree weight determined by the correlation-degree learning unit 203, whether a first event is a sign for any one of fault event types is described.

The correlation-degree analysis unit 202 computes, based on status values A₁ to Aₘ of other event types of a first monitoring target and a second monitoring target, status values X₁ to Xₙ of fault event types of the first monitoring target and the second monitoring target, and correlation-degree weights ω₁₁ to ωₘₙ determined by the correlation-degree learning unit 203, a correlation degree with another event type with respect to each fault event type, and analyzes, based on the computed correlation degree, whether a first event is a sign for any one of the fault event types.

The correlation-degree analysis unit 202 can compute, for example, based on a computational equation for “sign detection” in FIG. 3, the correlation degree described above. The illustrated computational equation indicates an equation for computing a correlation degree Fₖ of a k-th fault event type among n fault event types. Note that, a numerator of a right side of the illustrated computational equation is a value reflected with status values of all of a plurality of other sign events and a relation (correlation-degree weight) between each of a plurality of other sign events and a k-th fault event type, and immediately after occurrence of a first event, a status value of an event type to which the first event belongs is maximized and is most dominant. Therefore, the correlation degree Fₖ well representing a correlation between an event type to which the first event belongs and the k-th fault event type is computed. Note that, the computational equation illustrated in FIG. 3 is merely one example, and can be modified in a range where a similar advantageous effect is acquired.

The correlation-degree analysis unit 202 can estimate, when, for example, there is a fault event type in which a computed correlation degree is equal to or more than a reference value, that a first event is a sign for a fault indicated by the fault event type. On the other hand, when there is not a fault event type in which a computed correlation degree is equal to or more than the reference value, the correlation-degree analysis unit 202 can estimate that a first event is not a sign for a fault.

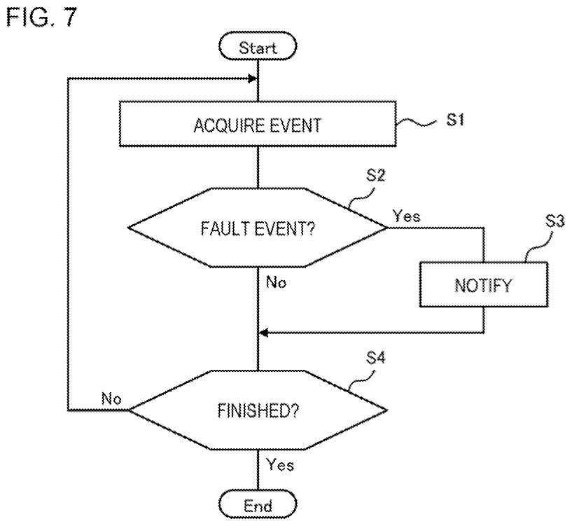

Next, using flowcharts in FIG. 7 to FIG. 10, one example of a flow of processing of the monitoring system 1 is described.

First, as illustrated in FIG. 7, when the monitoring control unit 102 acquires a new event from the monitoring execution unit 101 (Si), the monitoring control unit 102 confirms whether the event indicates a fault event (S2).

When a fault event is indicated (Yes in S2), the monitoring control unit 102 notifies a monitoring person of a fault occurrence (S3). Specifically, the monitoring control unit 102 causes the monitoring UI unit 103 to output information indicating an occurrence of a fault event. The output information can include a content of a fault event, discrimination information of a monitoring target in which the fault event is occurring, and the like.

On the other hand, when a fault event is not indicated (No in S2), the monitoring control unit 102 does not execute notification processing to a monitoring person.

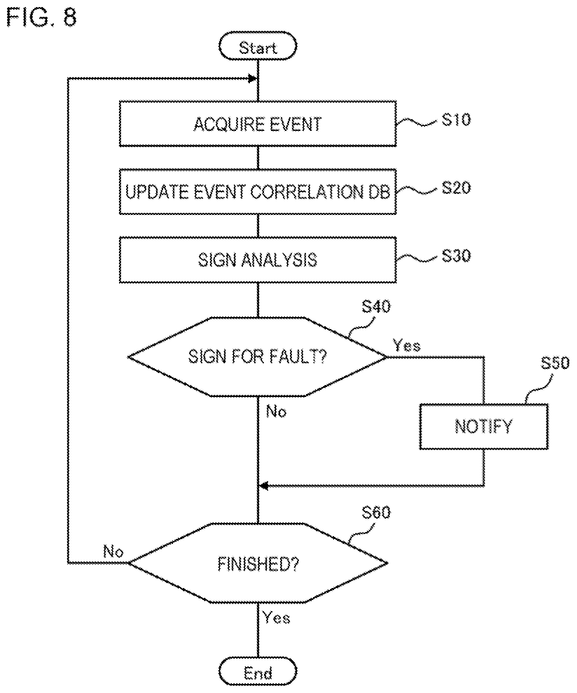

Further, as illustrated in FIG. 8, the monitoring control unit 102 transfers, when acquiring a new event from the monitoring execution unit 101 (S10), the event to the sign analysis/learning unit 2.

The event management unit 201 of the sign analysis/learning unit 2 updates, based on the new event, the event correlation DB 204 (S20).

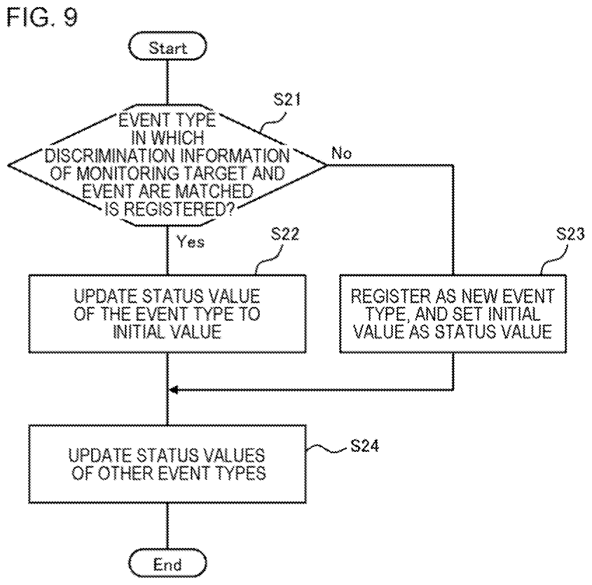

Herein, by using the flowchart in FIG. 9, one example of a flow of the processing in S20 is described. The event management unit 201 confirms whether an event type in which both of discrimination information of a monitoring target and an event being occurring in the monitoring target are matched with a new event is registered in the event correlation DB 204 (S21).

When being not registered (No in S21), the event management unit 201 registers the new event in the event correlation DB 204 as a new event type, and sets a previously-determined initial value as a status value (S23).

On the other hand, when being registered (Yes in S21), the event management unit 201 updates, to an initial value, a status value of an event type to which the new event belongs (S22).

Next, the event management unit 201 updates status vales of other event types registered in the event correlation DB 204 (S24). The event management unit 201 recomputes and updates, for example, based on a function in which a value gradually decreases in response to a time lapse such as a linearly decreasing function, an inversely proportional function, and the like and an elapsed time, a status value of each of event types registered in the event correlation DB 204. Note that, a processing order of the processing of S21 to S23 and the processing of S24 are not limited to the illustrated example.

Returning to FIG. 8, after the event correlation DB 204 is updated, a sign analysis based on the correlation-degree analysis unit 202 and the correlation-degree learning unit 203 is executed (S30).

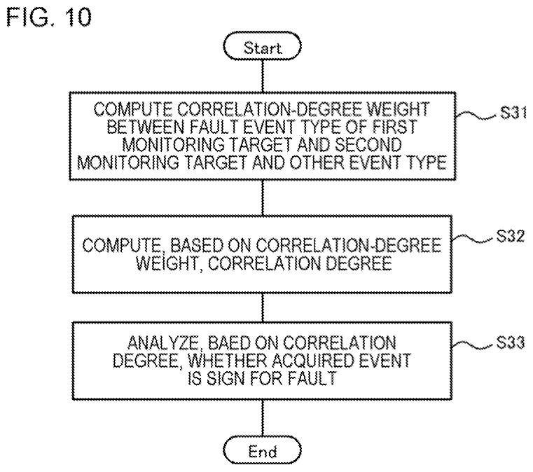

Herein, by using the flowchart in FIG. 10, one example of a flow of the processing in S30 is described. First, based on a latest event correlation DB 204, processing of computing a correlation-degree weight between a fault event type of a first monitoring target and a second monitoring target and other event type is executed (S31). Details of the processing have been described above, and therefore, description herein is omitted.

Next, processing of computing, for each fault event type of the first monitoring target and the second monitoring target, a correlation degree with other event types of the first monitoring target and the second monitoring target is executed (S32). Details of the processing have been described above, and therefore, description herein is omitted.

Next, based on the correlation degree computed in S32, processing of analyzing whether a new event is a sign for a fault is executed (S33). Details of the processing have been described above, and therefore, description herein is omitted.

Returning to FIG. 8, when it is determined, in S30, that a new event is a sign for a fault (Yes in S40), the monitoring control unit 102 notifies a monitoring person of an analysis result via the monitoring UI unit 103 (S50). The monitoring control unit 102 may cause the monitoring UI unit 103 to output, for example, information indicating a fault event type in which the correlation degree computed in S32 is equal to or more than a reference value. Note that, when there are a plurality of fault event types in which the correlation degree computed in S32 is equal to or more than the reference value, the monitoring control unit 102 may cause the monitoring UI unit 103 to output information indicating the plurality of fault event types. In this case, the monitoring control unit 102 may cause the monitoring UI unit 103 to output a correlation degree of each fault event type or a “certainty degree being a sign for each fault event type” computed based on the correlation degree.

On the other hand, when it is not determined, in S30, that a new event is a sign for a fault (No in S40), the monitoring control unit 102 does not notify of an analysis result via the monitoring UI unit 103.

Next, one example of a hardware configuration of the monitoring system 1 according to the present example embodiment is described. Each of functions included in the monitoring system 1 are achieved based on any combination of hardware and software mainly including a central processing unit (CPU) of any computer, a memory, a program loaded onto a memory, a storage unit storing the program such as a hard disk (capable of storing, in addition to a program stored previously at a stage of shipping an apparatus, a program downloaded from a storage medium such as a compact disc (CD) and a server or the like on the Internet), and a network connection interface. And, it should be understood by those of ordinary skill in the art that an achieving method and an apparatus therefor include various modified examples.

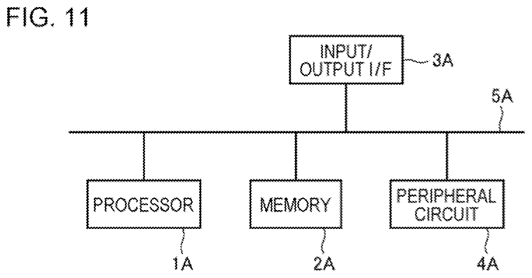

FIG. 11 is a block diagram illustrating a hardware configuration of the monitoring system 1. As illustrated in FIG. 11, the monitoring system 1 includes a processor 1A, a memory 2A, an input/output interface 3A, a peripheral circuit 4A, and a bus 5A. The peripheral circuit 4A includes various modules. Note that, the peripheral circuit 4A may not be necessarily included. Note that, the monitoring system 1 may be configured with one apparatus integrated physically and/or logically, or may be configured with a plurality of apparatuses separated physically and/or logically. When the monitoring system 1 is configured with a plurality of apparatuses separated physically and/or logically, each of the plurality of apparatuses can include the hardware configuration described above.

The bus 5A is a data transmission path where the processor 1A, the memory 2A, the peripheral circuit 4A, and the input/output interface 3A mutually transmit/receive data. The processor 1A is an arithmetic processing apparatus, for example, such as a CPU and a graphics processing unit (GPU). The memory 2A is a memory, for example, such as a random access memory (RAM) and a read only memory (ROM). The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a touch panel, a physical button, a camera, and the like. The output apparatus is, for example, a display, a speaker, a printer, a mailer, and the like. The processor 1A can issue an instruction to each of modules, and execute an arithmetic operation, based on arithmetic operation results therefrom.

Next, a working example of the monitoring system 1 according to the present example embodiment is described.

According to the monitoring system 1, the monitoring execution unit 101 monitors a situation of a monitoring target, and notifies, as an event, the monitoring control unit 102 of a monitoring result. Herein, the event includes monitoring target information and event information (indicating an event content, an importance-degree level, and the like). The importance-degree level indicates, in a stepwise manner, a matter ranging from an important fault to a simple information notification by using a numerical value, a label, or the like.

The monitoring control unit 102 first recognizes, when receiving an event from the monitoring execution unit 101, from monitoring target information, an increase/decrease of a monitoring target and a presence/absence of a configurational modification, and stores a recognized result in the configuration DB 301 as configuration information between monitoring targets.

Further, the monitoring control unit 102 notifies, in response to a content of event information, a monitoring person of an occurrence of an event to via the monitoring UI unit 103 (e.g., notifies when a fault event is indicated).

Further, the monitoring control unit 102 transmits the acquired event to the sign analysis/learning unit 2. Note that, when an occurrence of an event is notified (i.e., when a fault event is indicated), the monitoring control unit 102 transmits the event to the sign analysis/learning unit 2 by providing information being a “fault event”.

In the sign analysis/learning unit 2, the event management unit 201 receives an event. The event management unit 201 classifies whether a type (event type) of the event is known or unknown (i.e., whether to be registered in the event correlation DB 204) and whether to be a fault event. When a type of the event is unknown, the type is added to the event correlation DB 204 as a new event type. Whether to be a fault event is whether the event is notified to a monitoring person as a fault.

The sign analysis/learning unit 2 executes an operation for learning a correlation degree and an operation for sign detection based on the correlation degree.

First, an operation for correlation-degree learning is described. The event management unit 201 computes a status value of each of event types registered in the event correlation DB 204. A status value of an event type is set to be a maximum value at a time of occurrence, and is repeatedly computed and updated based on a function (FIG. 3) that gradually decreases as time elapses. As the function representing a gradual decrease, a linearly decreasing function, an inversely proportional function, and the like are conceivable, but a specific expression of a function is not specifically limited. With regard to an event having occurred, when, for example, a last status value is larger than a threshold, it is regarded that the same event repeatedly occurs and a value as-is is used, and when a last status value is smaller than a threshold, a maximum value is set as a new event. An event type other than an event having occurred is applied, based on a last status value, to a function, a status value is recomputed, and the recomputed status value is set as a new status value. These status values are stored in the event correlation DB 204.

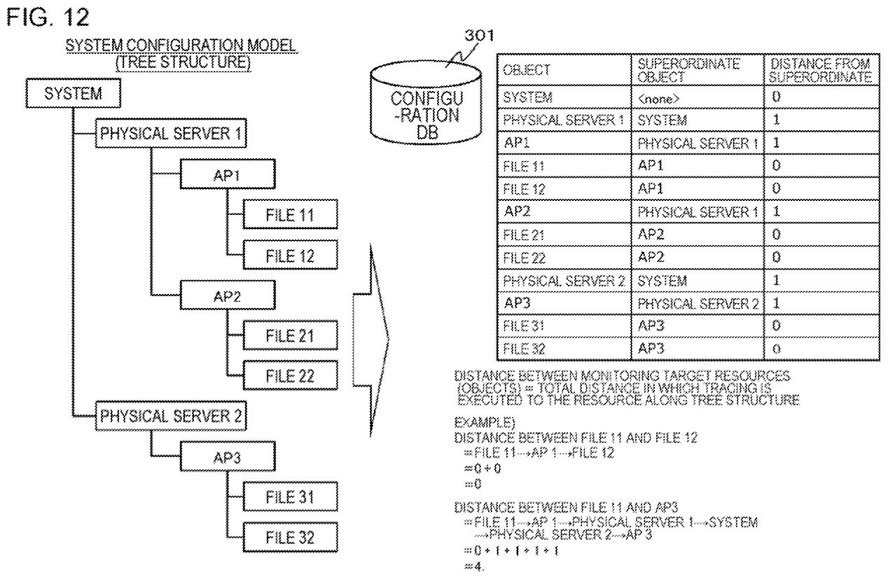

Next, by using, as a key, monitoring target information of a new event received by the event management unit 201, a configurationally-close monitoring target (a monitoring target satisfying a predetermined relation) is extracted from the configuration DB 301, a fault event type relating to a monitoring target (first monitoring target) indicated by the extracted configurationally-close monitoring target (a second monitoring target) and the key is extracted from the event correlation DB 204, and the extracted fault event type is caused to be a learning target for a correlation-degree weight with respect to the new event. As an extraction method for configurational closeness, a method of managing, based on a hierarchical tree structure, a configuration and determining, when there is a hierarchical relation in a layer, a difference in layer as closeness is conceivable, but not specifically limited. For example, as illustrated in FIG. 12, a distance between nodes is previously defined and the definition may be registered in the configuration DB 301. Then, the sign analysis/learning unit 2 may compute, based on the definition, a distance between two nodes. Then, the sign analysis/learning unit 2 may regard, as monitoring targets configurationally close to each other, two nodes in which the distance is equal to or less than a threshold.

With regard to a fault event type of a configurationally-close monitoring target extracted as a learning target and a new event received by the event management unit 201, for a correlation-degree weight thereof, an adjustment width of a correlation-degree weight is increased based on a relational expression as illustrated in FIG. 6 by the correlation-degree learning unit 203 as statuses of both events have a larger value (an occurrence state).

Thereby, learning in which as a frequency where both events occur in connection with each other is higher, a correlation-degree weight becomes larger is executed.

Next, an operation for sign detection is described. After the event correlation DB 204 is updated based on a new event received by the event management unit 201, the correlation-degree analysis unit 202 computes a correlation degree Fₖ for each fault event type, based on status values of event types indicated by the updated event correlation DB 204, a correlation-degree weight computed based on the updated event correlation DB 204, and the computational expression for “sign detection” illustrated in FIG. 6. Thereafter, the sign analysis/learning unit 2 notifies the monitoring control unit 102, as a pair, of a fault event type in which a correlation degree exceeds a previously-set threshold and a new event received by the event management unit 201. The monitoring control unit 102 provides, from the monitoring UI unit 103 to a monitoring person, that an event to be a sign for a fault has occurred.

Next, a modified example according to the present example embodiment is described. A correlation degree between each of a plurality of fault event types and other event types may be computed based on an N-on-one relation, or may be computed based on a one-on-one relation. When a one-on-one relation is employed, a correlation degree between another event type to which a new event (first event) acquired by the monitoring control unit 102 belongs and a fault event type can be computed. When computation is executed based on an N-on-one relation, it is conceivable that a mechanism for the computation is achieved based on a hierarchical neural network or the like.

Further, it is assumed that, when a sign for a fault is detected, the detection is notified to a monitoring person through the monitoring UI unit 103, but when coping determined for each fault exists, a configuration for providing the coping or a configuration for automatically executing coping can be newly incorporated.

Next, an advantageous effect according to the present example embodiment is described. The monitoring system 1 according to the present example embodiment executes self-learning, based on an event detected in a local system, and therefore it is unnecessary to prepare accurate training data as in supervised learning, and a model for sign detection is internally generated, whereby sign detection can be achieved.

Further, according to the present example embodiment, a causal relation between a sign event and a fault event is recognized as a magnitude of a correlation between events detected by the monitoring system 1, and the monitoring system 1 itself includes a mechanism for executing self-leaning for a causal relation independently of training data acquired manually or from an outside. Thereby, with regard to a problem on a causal relation having had difficulty in rulemaking based on <Method 1>, a causal relation can be found by a system itself. Further, guarantee for a causal relation resulting from exclusion of arbitrariness based on manual work having been a problem in <Method 2> can be achieved. Further, validity of training data being a problem in <Method 3> is solved based on a method without using training data.

The whole or part of the example embodiments described above can be described as, but not limited to, the following supplementary notes.
1. A monitoring system including:

a monitoring execution means that monitors each of a plurality of monitoring targets and outputs an event indicating discrimination information of the monitoring target and an event being occurring in the monitoring target;

an event management means that updates, based on the event output by the monitoring execution means, an event correlation database that stores information indicating event types having occurred and a status value indicating an occurrence of each of the event types and a magnitude of an elapsed time from the occurrence;

a correlation-degree analysis means that determines, based on configuration information indicating a mutual relation among the plurality of monitoring targets, one or a plurality of second monitoring targets having a predetermined relation with a first monitoring target relating to a first event output by the monitoring execution means;

a correlation-degree learning means that determines a correlation-degree weight between a fault event type indicating a fault occurrence among the event types of the first monitoring target and the second monitoring target and other event type, based on the status values of the fault event type and the other event type; and

a monitoring control means that outputs information to an output apparatus, wherein

the correlation-degree analysis means analyzes, based on the correlation-degree weight determined by the correlation-degree learning means, whether the first event is a sign for any one of the fault event types, and

the monitoring control means outputs an analysis result based on the correlation-degree analysis means.
2. The monitoring system according to supplementary note 1, wherein

the event management means
confirms, when the monitoring execution means outputs a new event, whether the event type in which both of discrimination information of the monitoring target and an event being occurring in the monitoring target are matched with the new event is registered in the event correlation database,
registers, when being not registered, the new event in the event correlation database as the new event type and registers an initial value as the status value, and
updates, when being registered, the status value of the event type to which the new event belongs to the initial value.
3. The monitoring system according to supplementary note 1 or 2, wherein

the event management means changes, in response to a time lapse, the status value registered in the event correlation database.
4. The monitoring system according to any one of supplementary notes 1 to 3, wherein

the correlation-degree learning means
repeatedly determines the correlation-degree weight, and
determines, in determination processing for the correlation-degree weight between a first fault event type and a first other event type at a first determination timing, as the correlation-degree weight, a value acquired by correcting, based on the status values of the first fault event type and the first other event type at the first determination timing, the correlation-degree weight between the first fault event type and the first other event type determined at a last determination timing.
5. The monitoring system according to supplementary note 4, wherein

the status value is maximum at a time of occurrence of the event and decreases as time elapses, and

the correlation-degree learning means increases an increase width of the correlation-degree weight based on correction as the status values of the first fault event type and the first other event type at the first determination timing are larger.
6. The monitoring system according to any one of supplementary notes 1 to 5, wherein

the correlation-degree analysis means computes, for each of the fault event types of the first monitoring target and the second monitoring target, a correlation degree with the other event types of the first monitoring target and the second monitoring target, and analyzes, based on the computed correlation degree, whether the first event is a sign for any one of the fault event types.
7. The monitoring system according to any one of supplementary notes 1 to 6, wherein

the monitoring control means updates, based on the event output by the monitoring execution means, the configuration information.
8. The monitoring system according to any one of supplementary notes 1 to 7, wherein

the monitoring control means outputs, when the event output by the monitoring execution means indicates a predetermined fault event, information indicating an occurrence of the fault event.
9. A monitoring method including:

by a computer,

monitoring each of a plurality of monitoring targets and outputting an event indicating discrimination information of the monitoring target and an event being occurring in the monitoring target;

updating, based on the event, an event correlation database that stores information indicating event types having occurred and a status value indicating an occurrence of each of the event types and a magnitude of an elapsed time from the occurrence;

determining, based on configuration information indicating a mutual relation among the plurality of monitoring targets, one or a plurality of second monitoring targets having a predetermined relation with a first monitoring target relating to a first event ;

determining a correlation-degree weight between a fault event type indicating a fault occurrence among the event types of the first monitoring target and the second monitoring target and other event type, based on the status values of the fault event type and the other event type ;

analyzing, based on the determined correlation-degree weight, whether the first event is a sign for any one of the fault event types; and

outputting an analysis result.
10. A program causing a computer to function as:

a monitoring execution means that monitors each of a plurality of monitoring targets and outputs an event indicating discrimination information of the monitoring target and an event being occurring in the monitoring target;

an event management means that updates, based on the event output by the monitoring execution means, an event correlation database that stores information indicating event types having occurred and a status value indicating an occurrence of each of the event types and a magnitude of an elapsed time from the occurrence;

a correlation-degree analysis means that determines, based on configuration information indicating a mutual relation among the plurality of monitoring targets, one or a plurality of second monitoring targets having a predetermined relation with a first monitoring target relating to a first event output by the monitoring execution means;

a correlation-degree learning means that determines a correlation-degree weight between a fault event type indicating a fault occurrence among the event types of the first monitoring target and the second monitoring target and other event type, based on the status values of the fault event type and the other event type; and

a monitoring control means that outputs information to an output apparatus, wherein

the correlation-degree analysis means analyzes, based on the correlation-degree weight determined by the correlation-degree learning means, whether the first event is a sign for any one of the fault event types, and

the monitoring control means outputs an analysis result based on the correlation-degree analysis means.

While the present invention has been described with reference to example embodiments (and a working example) thereof, the present invention is not limited to these example embodiments (and a working example) described above. It will be understood by those of ordinary skill in the art that various changes in form and details may be made therein without departing from the spirit and scope of the present invention as defined by the claims.

This application is based upon and claims the benefit of priority from Japanese patent application No. 2019-120168, filed on Jun. 27, 2019, the disclosure of which is incorporated herein in its entirety by reference.

What is claimed is:

1. A monitoring system comprising:
at least one memory configured to store one or more instructions; and
at least one processor configured to execute the one or more instructions to:
monitor each of a plurality of monitoring targets and output an event indicating discrimination information of the monitoring target and an event being occurring in the monitoring target;
update, based on the output event, an event correlation database that stores information indicating event types having occurred and a status value indicating an occurrence of each of the event types and a magnitude of an elapsed time from the occurrence;
determine, based on configuration information indicating a mutual relation among the plurality of monitoring targets, one or a plurality of second monitoring targets having a predetermined relation with a first monitoring target relating to a first output event;
determine a correlation-degree weight between a fault event type indicating a fault occurrence among the event types of the first monitoring target and the second monitoring target and other event type, based on the status values of the fault event type and the other event type; and
output information to an output apparatus, wherein
the at least one processor analyzes, based on the determined correlation-degree weight, whether the first event is a sign for any one of the fault event types, and
the at least one processor outputs an analysis results.

2. The monitoring system according to claim 1, wherein
the at least one processor
confirms, when the at least one processor outputs a new event, whether the event type in which both of discrimination information of the monitoring target and an event being occurring in the monitoring target are matched with the new event is registered in the event correlation database,
registers, when being not registered, the new event in the event correlation database as the new event type and registers an initial value as the status value, and
updates, when being registered, the status value of the event type to which the new event belongs to the initial value.

3. The monitoring system according to claim 1, wherein
the at least one processor changes, in response to a time lapse, the status value registered in the event correlation database.

4. The monitoring system according to claim 1 wherein
the at least one processor
repeatedly determines the correlation-degree weight, and
determines, in determination processing for the correlation-degree weight between a first fault event type and a first other event type at a first determination timing, as the correlation-degree weight, a value acquired by correcting, based on the status values of the first fault event type and the first other event type at the first determination timing, the correlation-degree weight between the first fault event type and the first other event type determined at a last determination timing.

5. The monitoring system according to claim 4, wherein
the status value is maximum at a time of occurrence of the event and decreases as time elapses, and
the at least one processor increases an increase width of the correlation-degree weight based on correction as the status values of the first fault event type and the first other event type at the first determination timing are larger.

6. The monitoring system according to claim 1 wherein
the at least one processor computes, for each of the fault event types of the first monitoring target and the second monitoring target, a correlation degree with the other event types of the first monitoring target and the second monitoring target, and analyzes, based on the computed correlation degree, whether the first event is a sign for any one of the fault event types.

7. The monitoring system according to claim 1, wherein
the at least one processor updates, based on the output event, the configuration information.

8. The monitoring system according to claim 1 wherein
the at least one processor outputs, when the output event indicates a predetermined fault event, information indicating an occurrence of the fault event.

9. A monitoring method comprising:
by a computer,
monitoring each of a plurality of monitoring targets and outputting an event indicating discrimination information of the monitoring target and an event being occurring in the monitoring target;
updating, based on the event, an event correlation database that stores information indicating event types having occurred and a status value indicating an occurrence of each of the event types and a magnitude of an elapsed time from the occurrence;
determining, based on configuration information indicating a mutual relation among the plurality of monitoring targets, one or a plurality of second monitoring targets having a predetermined relation with a first monitoring target relating to a first event;
determining a correlation-degree weight between a fault event type indicating a fault occurrence among the event types of the first monitoring target and the second monitoring target and other event type, based on the status values of the fault event type and the other event type;
analyzing, based on the determined correlation-degree weight, whether the first event is a sign for any one of the fault event types; and
outputting an analysis result.

10. A non-transitory storage medium storing a program causing a computer to:
monitor each of a plurality of monitoring targets and output an event indicating discrimination information of the monitoring target and an event being occurring in the monitoring target;
update, based on the output event, an event correlation database that stores information indicating event types having occurred and a status value indicating an occurrence of each of the event types and a magnitude of an elapsed time from the occurrence;
determine, based on configuration information indicating a mutual relation among the plurality of monitoring targets, one or a plurality of second monitoring targets having a predetermined relation with a first monitoring target relating to a first output event;
determine a correlation-degree weight between a fault event type indicating a fault occurrence among the event types of the first monitoring target and the second monitoring target and other event type, based on the status values of the fault event type and the other event type; and
output information to an output apparatus, wherein
the computer analyzes, based on the correlation-degree weight determined by the correlation-degree learning means, whether the first event is a sign for any one of the fault event types, and
the computer outputs an analysis result.
